(19) United States
(12) Patent Application Publication
(10) Pub. No.: US 2010/0127214 A1
(43) Pub. Date: May 27, 2010

(54) METHOD OF PREPARING OXIDE-BASED NANOPHOSPHOR

(75) Inventors: Soo-yeon SEO, Suwon-si (KR); Soon-jae KWON, Seongnam-si (KR); Hyun-sik KIM, Seoul (KR)

Correspondence Address: ROBERT E. BUSHNELL & LAW FIRM, 2029 K STREET NW, SUITE 600, WASHINGTON, DC, 20006-1004, US

(73) Assignee: Samsung SDI Co., Ltd., Suwon-si (KR)

(21) Appl. No.: 12/568,264

(22) Filed: Sep. 28, 2009

(30) Foreign Application Priority Data
Nov. 24, 2008 (KR) 10-2008-0117053

(51) Int. Cl. C09K 11/77; C09K 11/85

(52) U.S. Cl. 252/301.6 R; 252/301.4 H; 252/301.4 F

(57) ABSTRACT

A method of preparing oxide-based nanophosphor includes preparing a reaction mixture by dissolving reaction mixture components including a metal halide, an oleate, and a precipitation auxiliary compound in a solvent; irradiating the reaction mixture with microwave radiation to precipitate an oxide-based nanophosphor precursor; and sintering the oxide-based nanophosphor precursor.

### CLAIM OF PRIORITY

This application makes reference to, incorporates the same herein, and claims all benefits accruing under 35 U.S.C. §119 from an application earlier filed in the Korean Intellectual Property Office on Nov. 24, 2008 and there duly assigned Serial No. 10-2008-0117053.

### BACKGROUND OF THE INVENTION

1. Field of the Invention

One or more embodiments relate to a method of preparing an oxide-based nanophosphor, and more particularly, to a method of preparing an oxide-based nanophosphor, whereby an oxide-based nanophosphor having a narrow particle size distribution can be readily prepared.

2. Description of the Related Art

A phosphor is a material exhibiting luminescence characteristics obtained by energy excitation. In general, phosphors are used in various devices such as light sources, e.g., mercury fluorescent lamps or mercury-free fluorescent lamps, electron emission devices, plasma display panels (“PDPs”), and other such devices. Also, along with the development of new multimedia devices, phosphors are expected to be used in a wide variety of applications in the future.

Nanophosphors, also referred to as nano-sized phosphors, advantageously exhibit a lowered light scattering effect owing to their smaller size, when compared to conventional bulk-sized phosphors.

Requirements for nanophosphors include small particle sizes of typically several hundred nanometers or smaller in the largest dimension, separability of particles, high luminescence efficiency, and so on. Phosphors made of small and readily separable particles, however, often have limited luminescence efficiency. Conventional methods for compensating for such limited luminescence efficiency include raising the heating temperature, or increasing the heating time, during preparation of nanophosphors. However, increasing or prolonging heat may result in agglomeration of phosphor particles, and thus maintaining nano-sized phosphor particles may become difficult.

Among conventional methods of preparing nanophosphors, hydrothermal and/or solvothermal synthesis methods, or spray pyrolysis methods have typically been found advantageous in controlling the size, shape, and agglomeration of nanophosphor particles. A hydrothermal and/or solvothermal synthesis method is not economically suitable for synthesizing large quantities of nanophosphor particles however, due to slow reaction time and to the need for an autoclave that can withstand high temperatures and high pressures accompanying the use of a solvent. A spray pyrolysis method may be effective in controlling particle shape, but is not effective for producing efficient nanophosphor particles, that is, nanoparticles having high emission efficiency, due to structural defects in the resulting phosphors, such as hollowed particles. In another method of preparing nanophosphor particles, a separate inorganic salt is included which can impede crystal growth of the nanophosphor particles. However, since large amounts of inorganic salt need to be removed after each of these reactions, particle defects can occur during the removal of the inorganic salt, thereby reducing the efficiencies of the isolated nanophosphor particles.

### BRIEF SUMMARY OF THE INVENTION

One or more embodiments include a method of preparing an oxide-based nanophosphor, whereby an oxide-based nanophosphor having a narrow particle size distribution can be readily prepared.

One or more embodiments include a light-emitting device including an oxide-based nanophosphor doped with rare earth metal ions and prepared by the method of preparing the oxide-based nanophosphor.

Additional embodiments will be set forth in part in the description which follows and, in part, will be apparent from the description, or may be learned by practice of the invention.

To achieve the above, one or more embodiments include a method of preparing an oxide-based nanophosphor, including preparing a reaction mixture by dissolving reaction mixture components including a metal halide, an oleate, and a precipitation auxiliary compound in a solvent; irradiating the reaction mixture with microwave radiation to precipitate an oxide-based nanophosphor precursor; and sintering the oxide-based nanophosphor precursor.

The oxide-based nanophosphor is represented by Formula 1 below:

LnOₓ:M³⁺, Formula 1

wherein Ln may include at least one element selected from the group consisting of Mg, Ca, Sr, Ba, Zn, Mn, Al, Ga, B, Y, La, Ce, Gd, Eu, Ce, Pr, Dy, Tm, Tb, Er, Yb, Sm, Er, Bi, Sb, Ge, Si, and Sn,

M may include at least one element selected from the group consisting of Pr, Nd, Sm, Eu, Tb, Dy, Er, Mn, and Yb, and

x may be an integer of 1 to 20.

The reaction mixture may further include boric acid.

The oxide-based nanophosphor may be represented by Formula 2 below:

LnBO₃:M³⁺, Formula 2

wherein Ln may include at least one element selected from the group consisting of Y, La, Ce, Eu, Gd, Tb, Er, and Yb, and

M may include at least one element selected from the group consisting of Pr, Nd, Sm, Eu, Tb, Dy, Er, Mn, and Yb.

The oleate may include sodium oleate, potassium oleate, or ammonium oleate.

The precipitation auxiliary compound may include at least one compound selected from the group consisting of urea, citric acid, tartaric acid, oxalic acid, and hexadecanediol.

The solvent may include at least one solvent selected from the group consisting of water, methanol, ethanol, n-propanol, isopropanol, n-butanol, t-butanol, ethylene glycol, ethylene glycol monomethyl ether, ethylene glycol monoethyl ether, diethylene glycol, diethylene glycol monomethyl ether, propylene glycol, propylene glycol monomethyl ether, propylene glycol monoethyl ether, trimethylene glycol, glycerol, and 1,4-butylene glycol.

The molar ratio of the oleate to the metal halide may be about 0.03 to about 0.1.

The molar ratio of the precipitation auxiliary compound to the metal halide may be about 2 to about 5.

The molar ratio of the boric acid to the metal halide may be about 1 to about 1.2.

To achieve the above, one or more embodiments include a light-emitting device including the oxide-based nanophosphor prepared by the above method.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a diagram illustrating an exemplary method of preparing an oxide-based nanophosphor, according to an embodiment;

FIG. 2 is a scanning electron microscope (“SEM”) image of an exemplary YBO₃:Eu³⁺ nanophosphor synthesized in Example 1;

FIG. 3 is a graph illustrating a photoluminescence (“PL”) spectrum of the YBO₃:Eu³⁺ nanophosphor synthesized in Example 1 when the YBO₃:Eu³⁺ nanophosphor is excited with light having a wavelength of 254 nm; and

FIG. 4 is a graph illustrating a PL spectrum of the YBO₃:Eu³⁺ nanophosphor synthesized in Example 1 when the YBO₃:Eu³⁺ nanophosphor is excited with light having a wavelength of 147 nm.

### DETAILED DESCRIPTION OF THE INVENTION

A method of preparing an oxide-based nanophosphor and a light-emitting device including a nanophosphor prepared using the method will now be described with regard to embodiments in detail. In this regard, the present embodiments may have different forms and should not be construed as being limited to the descriptions set forth herein. Accordingly, the embodiments are merely described below, by referring to the figures, to explain aspects of the present description.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, regions, integers, steps, operations, elements, and/or components, but do not preclude the presence or addition of one or more other features, regions, integers, steps, operations, elements, components, and/or groups thereof. All ranges and endpoints reciting the same feature are independently combinable.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

As disclosed herein, “hydrothermal” refers to a process of synthesizing nanophosphors involving both water and heat. Also as disclosed herein, “solvothermal” refers to a process of synthesizing nanophosphors involving both a solvent other than or including water, and heat.

According to an embodiment, a method of preparing an oxide-based nanophosphor includes dissolving reaction mixture components including a metal halide, oleate, and a precipitation auxiliary compound in a solvent to provide a reaction mixture; irradiating the reaction mixture with microwave radiation to precipitate an oxide-based nanophosphor precursor; and sintering the oxide-based nanophosphor precursor.

In the method of preparing the oxide-based nanophosphor, inorganic salts generated as a by-product of irradiating the reaction mixture with microwave radiation is used to control crystal growth of nanophosphor particles.

In the method of preparing the oxide-based nanophosphor, the advantages of hydrothermal/ solvothermal synthesis methods are used in that a nanophosphor precursor having regular, consistent particle sizes is prepared by heat treatment with microwave radiation for a short time duration such as several minutes. In addition, nanophosphor particles having a high degree of crystallinity, and properties associated with high crystallinity, can be formed by a simple process in which a precipitated oxide-based nanophosphor precursor is heated in a solid state with an inorganic salt that is generated in situ during microwave irradiation of the reaction mixture, without need for adding a separate agglomeration controller or growth restrainer.

In the method of preparing the oxide-based nanophosphor, the time needed for synthesizing the oxide-based nanophosphor is remarkably reduced, the growth and agglomeration of oxide-based nanophosphor particles can be controlled, and the crystalline properties of the oxide-based nanophosphor particles can be improved, when compared with general methods such as a hydrothermal/ solvothermal synthesis methods.

The method of preparing the oxide-based nanophosphor will now be described in more detail.

First, the reaction mixture including the metal halide, the oleate, and the precipitation auxiliary compound are dissolved in the solvent so as to prepare a mixed reaction solution.

The metal halide is a precursor of a host and a dopant of the resulting nanophosphor, and a halide of two or more kinds of metals. The metal halide may be, for example, the fluoride, chloride, bromide, or iodide of Mg, Ca, Sr, Ba, Zn, Mn, Al, Ga, B, Y, La, Ce, Gd, Eu, Ce, Pr, Dy, Tm, Tb, Er, Yb, Sm, Er, Bi, Sb, Ge, Si, or Sn.

The method may be used to synthesize various oxide-based nanophosphors such as (Gd,Y,Sc,Lu,La)BO₃:Eu³⁺, (Gd,Y,Sc,Lu,La)₂O₃:Eu³⁺, (Gd,Y,Sc,Lu,La)(P,V)O₄:Eu³⁺, ZnGa₂O₄:Mn²⁺,Eu²⁺, (Ca,Sr,Ba)₂P₂O₇:Eu²⁺,Mn²⁺, (Ca,Sr,Ba)₅(PO₄)₃(Cl,F,Br,OH):Eu²⁺,Mn²⁺, ZnSiO₃:Mn²⁺, (Ca,Sr,Ba)MgAl₁₀O₁₇:Eu²⁺,Mn²⁺, (Ca,Sr,Ba)Al₂O₄:Eu²⁺, (Ca,Sr,Ba)BPO₅:Eu²⁺,Mn²⁺, Y₃Al₅O₁₂:Ce³⁺, (Ca,Sr,Ba)₂SiO₄:Eu²⁺, and (Ca,Sr,Ba)₃SiO₅:Eu²⁺. Note that as used herein, where multiple elements are disclosed parenthetically in a nanophosphor composition, the nanophosphor may include one or more of these elements, in varying proportions to achieve the stoichiometry defined. For example, a nanophosphor having the formula (Gd,Y,Sc,Lu,La)BO₃:Eu³⁺ may include one or more of Gd, Y, Lu, or La, not to exceed a total stoichiometry for these elements of one based on the molar amount of boron present. Further, the amount of dopant is shown as the dopant cation, but without reference to its stoichiometry or the anion paired with the dopant. Thus, for the above compound, Eu²⁺ is shown to be the dopant, and is present in an effective but otherwise unspecified amount.

An oxide-based nanophosphor prepared using the method may be represented by Formula 1.

LnOₓ:M³⁺ Formula 1

wherein Ln is at least one element selected from the group consisting of Mg, Ca, Sr, Ba, Zn, Mn, Al, Ga, B, Y, La, Ce, Gd, Eu, Ce, Pr, Dy, Tm, Tb, Er, Yb, Sm, Er, Bi, Sb, Ge, Si, and Sn,

M is at least one element selected from the group consisting of Pr, Nd, Sm, Eu, Tb, Dy, Er, and Yb, and

x is an integer of 1 to 20.

In the method of preparing the oxide-based nanophosphor, the reaction mixture may further include boric acid. In this case, the oxide-based nanophosphor may be represented by Formula 2.

LnBO₃:M³⁺ Formula 2

wherein,

Ln is at least one element selected from the group consisting of Y, La, Ce, Eu, Gd, Tb, Er, and Yb, and

M is at least one element selected from the group consisting of Pr, Nd, Sm, Eu, Tb, Dy, Er, Mn and Yb.

In the method of preparing the oxide-based nanophosphor, the oleate included in the reaction mixture may be sodium oleate, potassium oleate, ammonium oleate, or any combination thereof.

The oleate may be present in the form of a metal composite during the precipitation of the oxide-based nanophosphor precursor so as to form a metal precursor.

In the method of preparing the oxide-based nanophosphor, the precipitation auxiliary compound included in the reaction mixture may include at least one compound selected from the group consisting of urea, citric acid, tartaric acid, oxalic acid, and hexadecanediol. The precipitation auxiliary compound may be present in the form of a metal composite during the precipitation of the oxide-based nanophosphor precursor, and controls the precipitation of the oxide-based nanophosphor precursor.

The molar ratio of the oleate to the metal halide may be about 0.03 to about 0.1. When the molar ratio of the oleate to the metal halide is less than about 0.03, the metal oleate complex may not be formed in sufficient amounts. When the molar ratio of the oleate to the metal halide is greater than 0.1, a reaction residue may form, which is not desired.

The molar ratio of the precipitation auxiliary compound to the metal halide may be about 2 to about 5. When the molar ratio of the precipitation auxiliary compound to the metal halide is less than about 2, the precipitation may not take place smoothly, e.g., in an uncontrolled manner. When the molar ratio of the precipitation auxiliary compound o the metal halide is greater than about 5, the precipitation auxiliary compound may impede the preparation of the metal oleate complex.

The molar ratio of the boric acid to the metal halide may be about 1 to about 1.2. When the molar ratio of the boric acid to the metal halide is less than 1, a composition ratio of the resultant composition may not have appropriate stoichiometry when consideration is given to the high volatility of boric acid. When the molar ratio of the boric acid to the metal halide is greater than 1.2, another intermediate product may be generated.

The solvent used in preparing the mixed reaction solution may be, for example, water, methanol, ethanol, n-propanol, isopropanol, n-butanol, t-butanol, ethylene glycol, ethylene glycol monomethyl ether, ethylene glycol monoethyl ether, diethylene glycol, diethylene glycol monomethyl ether, propylene glycol, propylene glycol monomethyl ether, propylene glycol monoethyl ether, trimethylene glycol, glycerol, 1,4-butylene glycol, or the like, and may be used alone or in any combination of at least two thereof.

The amount of the solvent may be about 4 to 6 liters, specifically 4.5 to 5.5 liters, and in an exemplary embodiment, about 5 liters, per 1 mol of the metal halide.

As described above, the oxide-based nanophosphor precursor is precipitated by irradiating the reaction solution with microwave radiation, in which the reaction mixture components, including the metal halide, the oleate, and the precipitation auxiliary compound, are dissolved in the solvent.

The microwave radiation may be generated with a microwave oven.

Equation 3 below provides the theoretical amount of energy absorbed per unit volume for a predetermined material per hour, when the material is irradiated with microwave radiation. A microwave is an electromagnetic wave having a frequency of about 300 MHz to about 300 GHz.

P=2πf ε″σE²=σ′E² Equation 3

In Equation 3, P is the amount of absorbed energy (in units of power/volume), f is the microwave frequency, ε″ is the complex permittivity), σ is conductivity, and E is electric field strength.

For example, 0.1 mol of metal halide (dissolved in solvent to make a solution of 50 ml) is heated for about 3 to about 5 minutes by irradiating the solution with microwave radiation. When a nanophosphor is synthesized using a general hydrothermal/ solvothermal synthesis method, a long period of time, e.g., about 10 to about 20 hours, is required. However, when microwave radiation is used, a period of time of only several minutes to several tens of minutes is required.

The reaction mixture is thus heated by irradiating the reaction solution with microwave radiation at a temperature of about 150° C. to about 300° C. and at a pressure of about 20 to about 800 psi.

In the method of preparing the oxide-based nanophosphor, a halide derived from the metal halide of the reaction mixture, and a metal derived from the oleate of the reaction mixture, bond to form an inorganic salt. In addition, the inorganic salt may be used to control crystal growth of the oxide-based nanophosphor particles, for example by influencing equilibrium between the growing nanophosphor surface and agglomerating nanophosphor precursors in the reaction solution by competitive binding of the salts to the phosphor surface. Thus, without need for adding a separate inorganic salt, crystal growth can be controlled.

Further, in the method of preparing the oxide-based nanophosphor, the oxide-based nanophosphor precursor is precipitated from the reaction solution, and then a sintering operation is performed on the precipitated nanophosphor. During the sintering operation, the crystalline structure, and hence the associated properties, of the oxide-based nanophosphor particles can be further improved. The sintering operation may be performed at a temperature in the range of about 500 to about 1500° C. The sintering operation may be performed in air, inert atmosphere, or reducing atmosphere as desired.

After the sintering operation, a washing operation may be further performed in order to remove the inorganic salt on surfaces of the oxide-based nanophosphor particles. The nanoparticles may be washed with any suitable solvent, including deionized water, organic solvents, or mixtures thereof, without particular limitation.

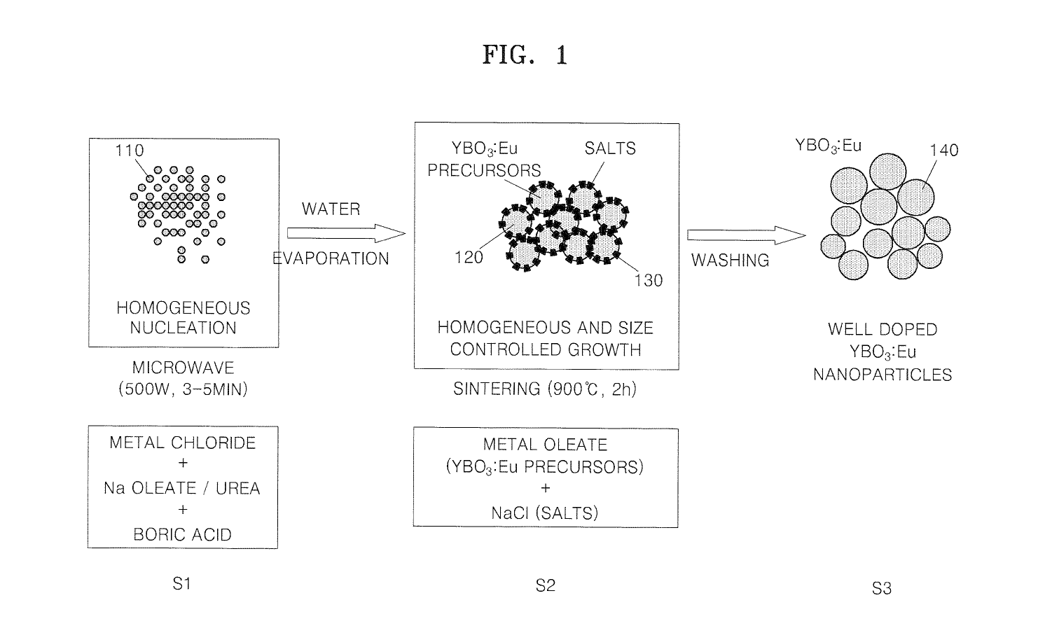

FIG. 1 is a diagram illustrating a method of preparing an oxide-based nanophosphor, according to an embodiment. With reference to FIG. 1, the method of preparing the oxide-based nanophosphor will be described in detail.

Referring to FIG. 1, in step S1, a mixed reaction solution is prepared by dissolving components including a mixture of yttrium chloride, europium chloride, sodium oleate, boric acid, and urea in a solvent including water, and irradiating the reaction solution with microwave energy of 500 W for 3 to 5 minutes. This causes reaction of the components and nucleation 110. Water is further removed by evaporation by microwave irradiation, thereby precipitating a nanophosphor precursor 120 in which yttrium boron oxide is doped with europium, as shown in step S2. Since the nanophosphor precursor 120 is surrounded by salts 120 such as sodium chloride (NaCl), crystal growth of particles of the precursor is controlled. That is, a metal halide and an oleate react with each other to prepare a metal oleate complex (e.g., YBO₃:Eu in step S2), which is then oxidized by reaction under air. After the reaction with irradiation by microwave radiation is performed, the nanophosphor precursor 120 is in the form in which the metal oleate complex is surrounded by NaCl (salts 130). The oxide-based nanophosphor is prepared, as shown in step S2, by sintering the precursor for about 2 hours at about 900° C. and washing the precursor to remove inorganic salts 130, to provide doped YBO₃:Eu nanoparticles 140 as shown in step S3.

As described above, in the method of preparing an oxide-based nanophosphor, the shape and size of the oxide-based nanophosphor particle can be readily controlled, and oxide-based nanophosphor particles having high crystallinity and associated properties can be synthesized with a short reaction time relative to comparative processes using hydrothermal/solvothermal methods.

In addition, many homogeneous nuclei (nuclei of similar size and shape and uniformity of composition) can be formed due to the rapid and regular heating process afforded by the use of microwave irradiation, and hence oxide-based nanophosphor particles having regular, uniform sizes can be formed by regular crystal growth.

In the method of preparing of the oxide-based nanophosphor, an oxide-based nanophosphor having a particle size of about 100 to about 200 nm can be formed.

The oxide-based nanophosphor particle may be highly regular, and in an embodiment, nearly spherical. It is well known that the shape of phosphor particles has a significant effect on the performance of a flat panel display which uses a phosphor. Compared to a phosphor prepared by a solid state reaction and having an irregular shape, phosphor particles having a nearly spherical shape can exhibit reduced light scattering effect for visible light generated by the phosphor, and can have a high packing density due to the regular shape, thereby increasing the brightness of the screen of the flat panel display thus affording high resolution for the flat panel display. Since vacuum ultra violet (“VUV”) light exhibits surface luminescence characteristics having a small penetration depth of about 100 to about 200 nm, the area and material of a surface of phosphor particles seriously affect the luminescent efficiency of the phosphor particles. Milling and pulverization operations may be further performed in order to form a desired shape of a phosphor. However, in the method of preparing the oxide-based nanophosphor, nanophosphors having a narrow particle size distribution and a nearly spherical shape can be prepared without need for such milling and pulverization operations, and therefore the oxide-based nanophosphor prepared by the method herein can obtain high efficiency and high definition of a plasma display panel (PDP) using VUV as an excitation source.

In an embodiment, the oxide-based nanophosphor prepared by the method of preparing the oxide-based nanophosphor which is doped with a rare earth metal ion, and which has a high degree of crystallinity, a narrow particle size distribution and a nearly spherical shape, can be used in an (ultra) high-resolution PDP. In another embodiment, the method of preparing the oxide-based nanophosphor, in which the size and shape of the oxide-based nanophosphor particles can be controlled, can be used to prepare UV-excited phosphor nanoparticles for excitation by a UV-LED. In another embodiment, the method can be applied to an inorganic electroluminescence device.

Hereinafter, the present invention will be described in more detail with reference to the following examples. However, the following examples are for illustrative purposes only and are not intended to limit the scope of the present invention.

### EXAMPLE 1

Yttrium chloride, europium chloride, H₃BO₃ (in a molar ratio of 0.88:0.12:1.2 respectively), and 0.005 mol of sodium oleate (based on 0.88 mol of yttrium chloride), and 0.3 mol of urea (based on 0.88 mol of yttrium chloride) were thoroughly stirred and mixed in 50 ml of water. The resultant mixture was irradiated with microwave radiation of 500W for 3 to 4 minutes at ambient pressure, to synthesize Y-B-O: Eu precursor particles in a dry state. The precursor particles were crystallized by heating the precursor particles for 2 hours at 900° C. in air, and residual inorganic salt was removed by washing with distilled water, thereby completing the preparation of YBO₃:Eu³⁺ nanophosphor particles having a diameter in the range of 100 to 200 nm.

### COMPARATIVE EXAMPLE 1

Yttrium oxide, europium oxide, and H₃BO₃ (in a molar ratio of 0.88:0.12:1.2, respectively) were mixed with an appropriate amount of ethanol to form a paste-like consistency, and was thoroughly mixed in a mortar. Then, the resultant mixture was put into an alumina crucible and heated for 2 hours at 1200° C. in air to crystallize particles of the mixture, thereby completing the preparation of bulk YBO₃:Eu³⁺ phosphor.

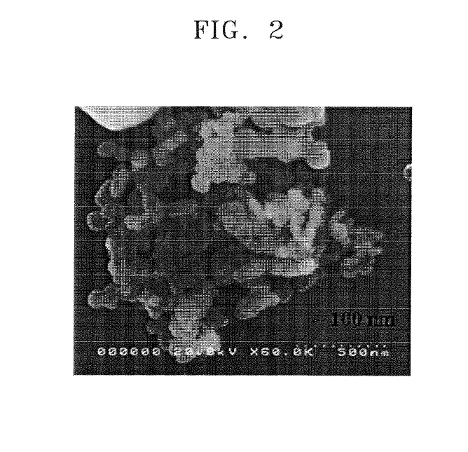

FIG. 2 is a scanning electron microscope (SEM) image of the YBO₃:Eu³⁺ nanophosphor synthesized in Example 1. Referring to FIG. 2, it can be seen that an oxide-based nanophosphor having a diameter equal to or less than 200 nm and narrow range of particle size distribution is obtained.

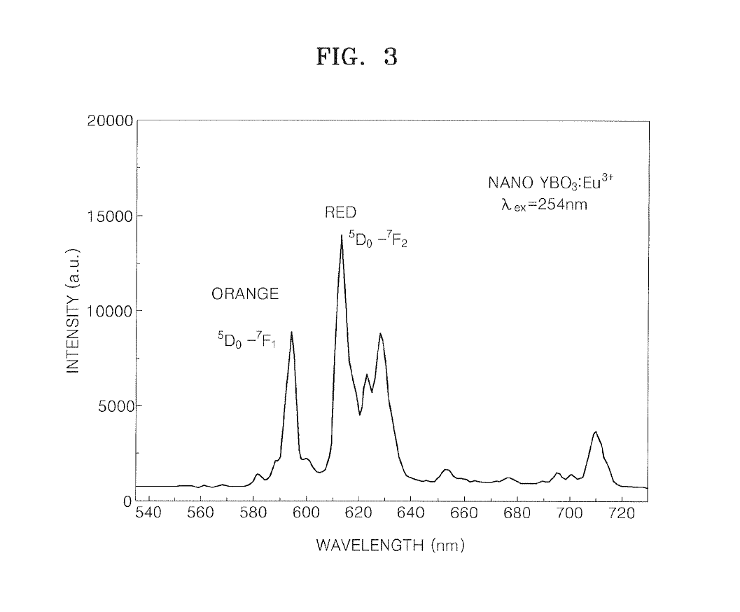

FIG. 3 is a graph of a photoluminescence (PL) spectrum of the YBO₃:Eu³⁺ nanophosphor synthesized in Example 1 where the YBO₃:Eu³⁺ nanophosphor was excited with light having a wavelength of 254 nm. Referring to FIG. 3, since the YBO₃:Eu³⁺ nanophosphor has a higher (more intense) red peak than orange peak, the YBO₃:Eu³⁺ nanophosphor can emit deep-red light. This is because the luminescence characteristics of Eu³⁺ are changed due to a greater surface area and high surface energy of the YBO₃:Eu³⁺ nanophosphor, and low symmetry of a crystal field surrounding Eu³⁺, thereby remarkably increasing the color purity of a red region.

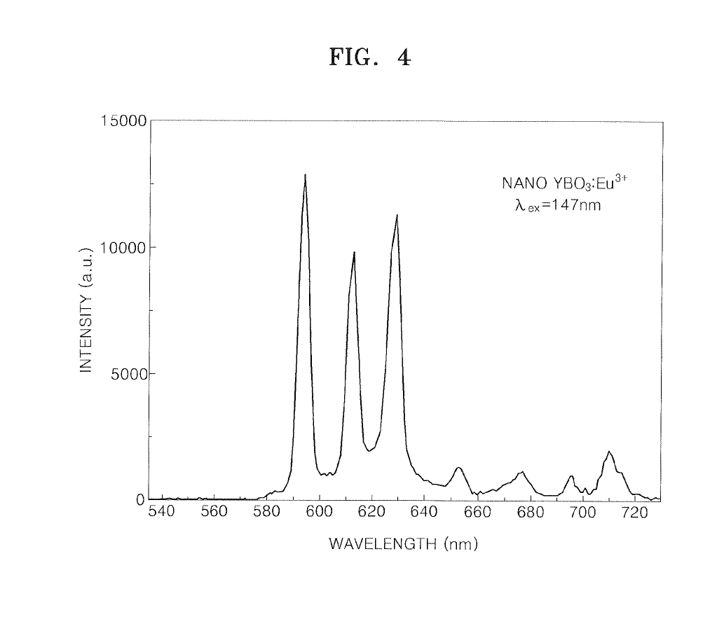

FIG. 4 is a graph of a PL spectrum of the YBO₃:Eu³⁺ nanophosphor synthesized in Example 1 when the YBO₃:Eu³⁺ nanophosphor was excited with vacuum UV light having a wavelength of 147 nm. Referring to FIG. 4, the YBO₃:Eu³⁺ nanophosphor has excellent brightness in spite of the small size thereof.

As described above, according to the one or more of the above embodiments, an oxide-based nanophosphor having narrow particle size distribution can be readily prepared.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A method of preparing an oxide-based nanophosphor, comprising:
preparing a reaction mixture by dissolving reaction mixture components including a metal halide, an oleate, and a precipitation auxiliary compound in a solvent; and
irradiating the reaction mixture with microwave radiation to precipitate an oxide-based nanophosphor precursor; and sintering the oxide-based nanophosphor precursor.

2. The method of claim 1, wherein the oxide-based nanophosphor is represented by Formula 1 below:
LnOₓ:M³⁺, Formula 1
wherein Ln comprises at least one element selected from the group consisting of Mg, Ca, Sr, Ba, Zn, Mn, Al, Ga, B, Y, La, Ce, Gd, Eu, Ce, Pr, Dy, Tm, Tb, Er, Yb, Sm, Er, Bi, Sb, Ge, Si, and Sn,
M comprises at least one element selected from the group consisting of Pr, Nd, Sm, Eu, Tb, Dy, Er, Mn, and Yb, and
x is an integer of 1 to 20.

3. The method of claim 1, wherein the oleate comprises sodium oleate, potassium oleate, ammonium oleate, or any combination thereof.

4. The method of claim 1, wherein the precipitation auxiliary compound comprises at least one compound selected from the group consisting of urea, citric acid, tartaric acid, oxalic acid, and hexadecanediol.

5. The method of claim 1, wherein the solvent comprises at least one selected from the group consisting of water, methanol, ethanol, n-propanol, isopropanol, n-butanol, t-butanol, ethylene glycol, ethylene glycol monomethyl ether, ethylene glycol monoethyl ether, diethylene glycol, diethylene glycol monomethyl ether, propylene glycol, propylene glycol monomethyl ether, propylene glycol monoethyl ether, trimethylene glycol, glycerol, and 1,4-butylene glycol.

6. The method of claim 1, wherein the molar ratio of the oleate to the metal halide is about 0.03 to about 0.1.

7. The method of claim 1, wherein the molar ratio of the precipitation auxiliary compound to the metal halide is about 2 to about 5.

8. The method of claim 1, wherein the reaction mixture further comprises boric acid.

9. The method of claim 8, wherein the oxide-based nanophosphor is represented by Formula 2 below:
LnBO₃:M³⁺, Formula 2
wherein Ln comprises at least one element selected from the group consisting of Y, La, Ce, Eu, Gd, Tb, Er, and Yb, and
M comprises at least one element selected from the group consisting of Pr, Nd, Sm, Eu, Tb, Dy, Er, Mn, and Yb.

10. The method of claim 8, wherein the molar ratio of the boric acid to the metal halide is about 1 to about 1.2.

11. A light-emitting device comprising the oxide-based nanophosphor prepared using the method of claim 1.
